(19) United States
(12) Patent Application Publication
(10) Pub. No.: US 2025/0069832 A1
(43) Pub. Date: Feb. 27, 2025

(54) DUAL-CONTACT POWER CONTACTOR

(71) Applicant: SAFRAN ELECTRICAL & POWER, Blagnac (FR)

(72) Inventors: Kévin ENOUF, Moissy-Cramayel (FR); Guillaume PRIEUR, Moissy-Cramayel (FR); Cecil BELTAN, Moissy-Cramayel (FR)

(73) Assignee: SAFRAN ELECTRICAL & POWER, Blagnac (FR)

(21) Appl. No.: 18/720,795

(22) PCT Filed: Dec. 14, 2022
(86) PCT No.: PCT/FR2022/052344

§ 371 Date: Jun. 17, 2024

(30) Foreign Application Priority Data
Dec. 17, 2021 (FR) FR2113887

(51) Int. Cl. H01H 50/04; H01H 9/38; H01H 50/54

(52) U.S. Cl. CPC H01H 50/045; H01H 9/38; H01H 50/546

(57) ABSTRACT

A power contactor including: a fixed part including two fixed elements; a moveable part able to come into contact with the fixed part and to move between an open position and closed position of the contactor, the moveable part including two switching elements and two conducting elements, and the distance between the fixed part and the two conducting elements being greater than the distance between the fixed part and the two switching elements in open position of the contactor, such that the switching elements come into contact with the fixed part before the conducting elements when the contactor changes from open position to closed position; and a motor configured to actuate and place the moveable part in contact with the fixed part.

### TECHNICAL FIELD

The present disclosure relates to the general field of electrical protection systems such as electromagnetic contactors and circuit breakers.

### PRIOR ART

Power contactors are electrical protection devices composed of a fixed part (formed of two fixed elements) and a moveable part (formed of two moveable elements) able to be in contact or not to be in contact with the fixed part.

To close a contactor, and therefore press the moveable part against the fixed part so that an electric current is able to circulate between the fixed part and the moveable part, the motor of the contactor is powered which will allow a force to be applied to the moveable part and thereby allow the flowing of electric current between the moveable part and the fixed part.

When the current circulating between the two parts exceeds a certain threshold, repulsion electromagnetic forces will be applied to the moveable part to offset and even exceed the force applied by the motor to the moveable part. This leads to levitation of the contactor i.e. non-desired opening between the fixed and moveable parts. In addition, at this phase, i.e. during application of repulsion forces before levitation, the contact resistance between the fixed part and moveable part of the contactor increases and creates local heating (proportional to the square of contact resistance multiplied by the current) which can lead to destruction of the moveable part and irreversible damage to the contactor.

At the current time, to increase the resistance of contactors to strong currents, it is possible to increase the contact force between the fixed and moveable parts using a more powerful motor. Nevertheless, this solution is ill-adapted to aeronautic installations since an increase in motor power would entail an increase in the mass of the motor.

It is therefore desirable to have available a novel power contactor that can withstand strong currents e.g. higher than 5 kA, whilst maintaining a motor of reduced size.

### DISCLOSURE OF THE INVENTION

The invention relates to a power contactor comprising:
a fixed part comprising two fixed elements;
a moveable part able to come into contact with the fixed part and to move between an open position and a closed position of the contactor, the moveable part comprising two switching elements and two conducting elements, and the distance between the fixed part and the two conducting elements being greater than the distance between the fixed part and the two switching elements in the open position of the contactor, such that the switching elements come into in contact with the fixed part before the conducting elements when the contactor changes from the open position to the closed position; and
a motor configured to actuate and place the moveable part in contact with the fixed part.

By having a moveable part comprising four elements, the number of contact points between the fixed part and the moveable part is increased, thereby allowing a reduction in the electric current circulating at each contact point. Local heating at each contact point is therefore decreased compared with a conventional contactor.

In addition, since the number of contact points of the current is doubled compared with a conventional contactor, repulsive forces are accordingly halved. By using the same motor and same power as in the prior art, it is therefore possible to cause twice times more electric current to flow at the contact points without levitation of the contactor and local heating, and even without damage occurring at the contact points.

Also, since the switching elements open after the conducting elements when the contactor is opened, it is known where electric arcs occur. It is therefore possible to choose the suitable materials and/or geometries to be used for the switching and conducting elements.

Additionally, in a contactor of the invention (dual-contact contactor), at the time of closing, the pressing forces to obtain contact between the switching elements and the fixed part, and contact between the conducting elements and the fixed part, are staggered in time. This specificity better corresponds to the increase in electromagnetic forces to be supplied by the motor at the time of closing. It is therefore possible to increase the pressing forces on the switching and conducting contacts whilst remaining below the electromagnetic forces supplied by the motor; therefore with the invention the resistance to levitation is at least doubled.

In one particular characteristic of the invention, the switching elements and conducting elements are mounted in parallel on one same shaft.

This makes it possible to have linear movement of the moveable part between opening and closing of the contactor, and to obtain a compact contactor.

According to another particular characteristic of the invention, the material of the switching elements differs from the material of the conducting elements.

This allows the use for example of a material conducive to the displacement of an electric arc or a material exhibiting lesser erosion over time for the switching elements, compared with the constituent material of the conducting elements.

For example, the switching elements are in silver tin oxide (AgSnO₂) and the conducting elements in pure silver.

According to another particular characteristic of the invention, the switching elements and the conducting elements are in one same material. For example, they are in pure silver, in particular for high voltage applications (higher than 40 V).

According to another particular aspect of the invention, the contactor comprises at least one spring positioned between the motor and the switching elements, to apply pressure on the switching elements, and at least one spring positioned between the motor and the conducting elements to apply pressure on the conducting elements.

By choosing the characteristics of the springs, it is possible to adapt the pressure force applied by the motor to the conducting and switching elements to place them in contact with the fixed part.

A further subject of the invention is a method of closing a power contactor of the invention that is in open position, comprising placing the switching elements in contact with the fixed part, followed by placing the conducting elements in contact with the fixed part.

With the closure method of the invention, by having the switching elements closing before the conducting elements, it is known that the electric arcs will occur on these elements. In addition, as previously explained, by increasing the number of contact points of the electric current between the moveable part and the fixed part, the repulsion forces are decreased which improves contactor resistance to strong currents.

A further subject of the invention is a method of opening a power contactor of the invention that is in the closed position, comprising the opening of the contact between the conducting elements and the fixed part, followed by opening of the contact between the switching elements and the fixed part.

At the time of opening, since the conducting elements are the first to open, only the switching elements could be subject to electric arcing which occurs at the time of electrical separation.

### BRIEF DESCRIPTION OF THE DRAWINGS

Other characteristics and advantages of the present invention will become apparent from the description below given with reference to the appended drawings which illustrate examples of embodiment that are not in any respect limiting.

FIG. 1 is a schematic, partial illustration of a power contactor in open position, in one embodiment of the invention.

FIG. 2A is a schematic, partial illustration showing a cross-section of a power contactor in open position, in one embodiment of the invention.

FIG. 2B is a schematic, partial illustration showing a cross-section of a power contactor between an open position and closed position, in one embodiment of the invention.

FIG. 2C is a schematic, partial illustration showing a cross-section of a power contactor in closed position, in one embodiment of the invention.

FIG. 3 schematically illustrates a method of closing a power contactor, in one embodiment of the invention.

FIG. 4 schematically illustrates a method of opening a power contactor, in one embodiment of the invention.

### DESCRIPTION OF EMBODIMENTS

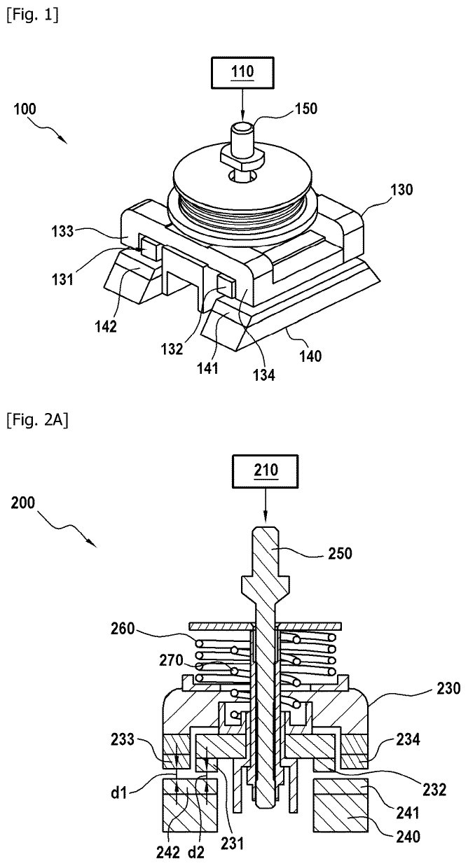

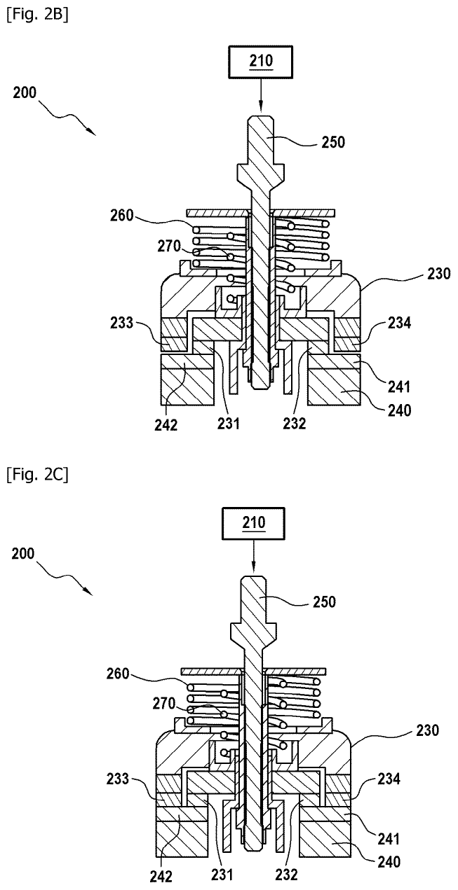

FIGS. 1 and 2A, schematically and partially, illustrate a power contactor 100, 200 in open position, FIG. 2A being a cross-sectional view of the contactor in FIG. 1.

The power contactor 100, 200 comprises a motor 110, 210, a fixed part 140, 240 comprising two fixed elements 141, 142, 241, 242 and a moveable part 130, 230 able to be brought into contact with the fixed part 140, 240. The moveable part 130, 230 can move between an open position and closed position of the contactor.

In open position, the fixed part and moveable part are not in contact, and no electric currents flows therebetween. In closed position, the fixed part and moveable part are in contact such that an electric current flows between the two parts.

The moveable part 130, 230 comprises two switching elements 131, 132, 231, 232 and two conducting elements 133, 134, 233, 234. The distance d1 between the fixed part 140, 240 and the conducting elements 133, 134, 233, 234 is greater than the distance d2 between the fixed part 140, 240 and the switching elements 131, 132, 231, 232.

In this example of embodiment, the conducting elements 133, 134, 233, 234 are mounted in parallel with the switching elements 131, 132, 231, 232 on one same shaft 150, 250.

The contactor 200 also comprises a spring 270 placed around the shaft 250 between the motor 210 and the switching elements 231, 232 such as to apply pressure on the switching elements, and a spring 260 placed around the shaft 250 between the motor 210 and the conducting elements 233, 234 such as to apply pressure on the conducting elements 233, 234.

The two springs 260, 270 each apply an initial force to the moveable part 230 when the contactor is in open position.

The motor 110, 210 can be an electromagnetic motor comprising a coil, or a mechanical motor.

The power contactor 100, 200 may also comprise means to control the motor 110, 210, to power or shut off the motor 110, 210 for closing or opening of the contactor 100, 200.

FIG. 2B illustrates the contactor 200 in the course of being opened or closed i.e. at the time of changing over from open position to closed position (and conversely), while FIG. 2C illustrates the contactor 200 in closed position.

To close the contactor 200, the motor 210 is powered and via a contact force given by the motor 210 and asserting force given by the springs 260 and 270, the switching elements 231 and 232 at a first stage are placed in contact on the fixed elements 241 and 242. These forces allow the switching elements 231, 232 to be held under mechanical pressure on the fixed elements 241, 242. The contactor 200 is then in semi-open (or semi-closed) state as illustrated in FIG. 2B. In this state, electric arcs may occur between the elements 241, 242 of the fixed part 240 and the switching elements 231, 232. No electric current flows between the fixed part 240 and the conducting elements 241 and 242 in this state.

At a second stage, the conducting elements 233, 234 are placed in contact with the elements 241, 242 of the fixed part 240. An electric current is then able to flow between the fixed part 240 and the conducting elements 241, 242 and between the fixed part 240 and the switching elements 231, 232, via the four contact points formed between the pairs of elements 233 and 242, 231 and 242, 232 and 241, 234 and 241. The contactor 200 is then in closed position, as illustrated in FIG. 2C.

To open the contactor 200, the power is shut off to the motor 210, and the conducting elements 233, 234 will open first (as illustrated in FIG. 2B), followed by opening of the switching elements 231, 232 (as illustrated in FIG. 2A).

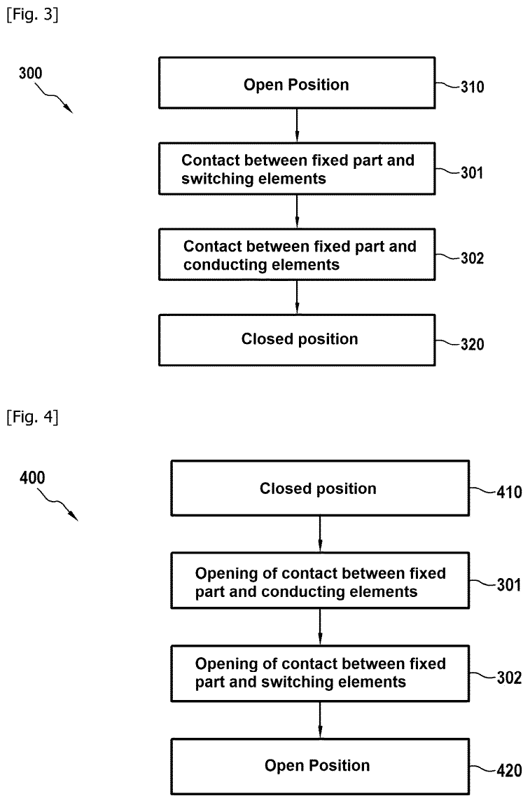

FIG. 3 schematically illustrates a method 300 of closing a power contactor in one embodiment of the invention.

The contactor is initially in open position 310, therefore the fixed and moveable parts are not in contact and no electric current flows between these two parts.

For the contactor to change over to closed position 320, the motor is powered and is able to apply a pressure force on the moveable part of the contactor, and the switching elements are first placed in contact with the fixed part (step 301), after which the conducting elements are placed in contact with the fixed part (step 302).

FIG. 4 schematically illustrates a method 400 of opening a power contactor in one embodiment of the invention.

The contactor is initially in closed position 410, therefore the fixed and moveable parts are in contact and an electric current flows between these two parts.

For the contactor to change over to open position 420, power to the motor is shut off and the conducting elements open first (step 401). They are therefore no longer in contact with the fixed part of the contactor, and electric arcing may occur between the switching elements and the fixed part. Opening of the switching elements then takes place (step 402).

1. A power contactor comprising:
a fixed part comprising two fixed elements;
a moveable part able to come into contact with the fixed part and to move between an open position and a closed position of the contactor, the moveable part comprising two switching elements and two conducting elements, and the distance between the fixed part and the two conducting elements being greater than the distance between the fixed part and the two switching elements in open position of the contactor, such that the switching elements come into contact with the fixed part before the conducting elements when the contactor changes from open position to closed position; and
a motor configured to actuate the moveable part and to place it in contact with the fixed part, wherein the switching elements and conducting elements are mounted in parallel on one same shaft and in that the contactor comprises at least one spring positioned between the motor and the switching elements to apply pressure on the switching elements, and at least one spring positioned between the motor and the conducting elements to apply pressure on the conducting elements.

2. The power contactor according to claim 1, wherein the material of the switching elements differs from the material of the conducting elements.

3. A method of closing a power contactor in open position according to claim 1, comprising the contacting of the switching elements with the fixed part, followed by contacting of the conducting elements with the fixed part.

4. A method of opening a power contactor in closed position according to claim 1, comprising the opening of the contact between the conducting elements and the fixed part, followed by opening of the contact between the switching elements and the fixed part.
